(19) United States
(12) Patent Application Publication
(10) Pub. No.: US 2005/0089023 A1
(43) Pub. Date: Apr. 28, 2005

(54) Architecture for an extensible real-time collaboration system

(75) Inventors: Warren V. Barkley, Mill Creek, WA (US); Stephanie A. Lindsey, Redmond, WA (US)

Correspondence Address: PERKINS COLE LLP/MSFT, P. O. BOX 1247, SEATTLE, WA, 98111-1247, US

(73) Assignee: Microsoft Corporation, Redmond, WA (US)

(21) Appl. No.: 10/923,598

(22) Filed: Aug. 20, 2004

Related U.S. Application Data
(60) Provisional application No. 60/513,790, filed on Oct. 23, 2003.

(51) Int. Cl. H04L 12/66

(52) U.S. Cl. 370/352

(57) ABSTRACT

An architecture for an extensible real-time collaboration system providing a unified interface is provided. The architecture presents a unified application program interface for writing application programs that use communications protocols. The architecture has presence and activity objects, multiple endpoint objects, and a collaboration service object. These objects may use various communications protocols, such as Session Initiation Protocol or Real-Time Transport Protocol, to send and receive messages. The presence and activities objects, multiple endpoint objects, and collaboration service object may each have one or more APIs that an application developer can use to access or provide various functionalities. These objects map the API to the underlying implementation provided by other objects.

### CROSS-REFERENCE TO RELATED APPLICATION(S)

This application claims the benefit of U.S. Provisional Application Nos. 60/513,790, entitled ______, filed on Oct. 23, 2003, and ______, entitled “Real-Time Collaboration Systems,” filed on Aug. 6, 2004, and identified by attorney docket number 41826-8067US00, the disclosures of which are both incorporated herein in their entirety by reference. This application is related to U.S. patent application Ser. No. ______, entitled “Architecture for an Extensible Real-Time Collaboration System,” filed on Aug. 14, 2004, and identified by Attorney Docket No. 41826-8024US01, the disclosure of which is incorporated in its entirety by reference.

### TECHNICAL FIELD

The described technology relates generally to data communications and, more particularly, to an architecture for an extensible real-time collaboration system providing a unified interface.

### BACKGROUND

Various communications applications and protocols enable communications between software programs or users. As examples, real-time communications applications such as MICROSOFT WINDOWS MESSENGER and Voice over Internet Protocol (“VoIP”) enable communications between users sending each other text or voice messages. These applications may use various protocols, such as Session Initiation Protocol (“SIP”), Real-Time Transport Protocol (“RTP”), and Real-Time Control Protocol (“RTCP”), to establish sessions and send communications-related information. SIP is an application-layer control protocol that devices can use to discover one another and to establish, modify, and terminate sessions between devices. RTP is a protocol for delivering audio and video over the Internet, and is frequently used in streaming media systems and videoconferencing systems with other protocols such as RTCP and H.323. RTCP is a protocol that enables a client application to monitor and control data sent or received using RTP, and is used with RTP. SIP and RTP/RTCP are Internet proposed standards. Their specifications, “RFC 3261” and “RFC 3550,” and respectively, are available on the Internet at www.ietf.org at /rfc/rfc3261.txt and www.faqs.org at /rfcs/rfc3550.html, respectively, and are incorporated herein in their entirety by reference.

Applications may additionally use other protocols. Applications may use enhanced versions of the protocols indicated above or altogether different protocols that are designed to carry specialized data. As an example, when a new or improved protocol for carrying videoconferencing information becomes available, an application developer creating or modifying an application may desire to use the new or improved protocol, e.g., to improve performance or offer additional features. To use the new or improved protocol, the application developer may need to modify portions of the application that interact with communications protocols because an improvement to a protocol or a new protocol may have a different interface than a protocol already being used. As an example, while a protocol may have a NewSession interface to send a message, an improved version may have a StartSession method that accepts additional parameters. Because StartSession accepts additional parameters, its interface is different from NewSession, and so an application using NewSession may need to be modified to use StartSession. When a protocol has a different interface, application developers need to learn the different interface and modify their applications to use this interface to use the protocol.

Application developers may need to become familiar with details of each of the many communications protocols they use in applications they develop. As an example, when an application developer uses SIP and RTP/RTCP, the application developer may need to be familiar with all three protocols to provide program logic relating to the protocols. An application developer not familiar with all three protocols may need additional training and time to become familiar with these protocols. Furthermore, when the application is to be modified to work with additional or improved protocols, the application developer may need to revise or add programming logic so that the application can function with these protocols. This could lead to additional development expense and difficulty.

Furthermore, various protocols present a variety of complexities. For example, to provide a videoconferencing facility in an application, the application's developer would have to become familiar with a number of protocols and provide logic to coordinate these protocols to add videoconferencing capabilities. Adding other collaboration capabilities to an application, such as text messaging, voice messaging, etc., presents other similar complexities.

Thus, an architecture for an extensible real-time collaboration system that facilitates addition of collaboration features in an application without significant investment in developer training would have significant utility.

### SUMMARY

An architecture for an extensible real-time collaboration system is provided. The architecture presents a unified application program interface (“API”) for writing application programs that use communications protocols. The architecture has presence and activities objects, multiple endpoint objects, and a collaboration service object. These objects may use various communications protocols, such as Session Initiation Protocol or Real-Time Transport Protocol, to send and receive messages containing information. The presence and activities objects, multiple endpoint objects, and collaboration service object may each have one or more APIs that an application developer can use to access or provide various functionalities. These objects map the API to the underlying implementation provided by other objects. The collaboration service object may route collaboration events to an application based on policy, preference, capability, or availability. It may also consolidate information, such as presence information and collaboration events, for applications.

### BRIEF DESCRIPTION OF THE DRAWINGS

FIG. 1 is a block diagram illustrating components of an architecture for an extensible real-time collaboration system in an embodiment.

FIG. 2 is a block diagram illustrating components of an endpoint object of the extensible real-time collaboration system in an embodiment.

FIG. 3 is a block diagram illustrating activities objects of the extensible real-time collaboration system in an embodiment.

FIG. 4 is a flow diagram illustrating a create_server_endpoint routine in an embodiment.

FIG. 5 is a block diagram illustrating a collaboration service object in an embodiment.

FIG. 6 is a flow diagram illustrating a startup routine performed by a collaboration service object in an embodiment.

FIG. 7 is a flow diagram illustrating a listen routine performed by a collaboration service object in an embodiment.

FIG. 8 is a flow diagram illustrating a routine for determining a suitable application in an embodiment.

FIG. 9 is a flow diagram illustrating a routine for evaluating suitable applications in an embodiment.

### DETAILED DESCRIPTION

In an embodiment, an architecture for an extensible real-time collaboration system providing a unified interface is provided. The architecture provides a unified application program interface (“API”) for writing application programs that use communications protocols, and includes a collaboration service object that coordinates other objects to perform collaboration services requested by applications. In the architecture, various objects, such as protocols for transporting media, can be added, replaced, or modified. When protocols are added, replaced, or modified, an application using the architecture may not need to be reprogrammed to use the modified or added protocol because the application uses the unified API.

The architecture comprises a collaboration service object, activity object, and multiple endpoint objects. These objects may use various communications protocols, such as SIP or RTP, to send and receive messages. The collaboration service object, activity object, and multiple endpoint objects may each have one or more APIs that an application developer can use to access or provide various functionality provided by the objects.

When objects are added or modified, an application using the architecture may not need to be modified because it uses a unified API provided by the architecture. The architecture may map these unified API interfaces to interfaces provided by the new or updated objects. As an example, the RTP/RTCP protocol can be replaced with a new protocol capable of efficiently carrying real-time video information. The application could continue to use the APIs provided by the collaboration service object, presence and activity object, and multiple endpoint objects unfettered by changes in the actual protocol being used. Furthermore, the application developer may not need to spend time to understand the new protocol in detail, thereby saving development time and costs.

The collaboration service object provides a routing service for incoming collaboration events. The incoming collaboration events may be provided to the collaboration service object by an endpoint object. As an example, when a collaboration session is requested by an application that involves videoconferencing, the collaboration service object may determine a user's presence status, invite the user to a videoconference, and exchange audio/video information. These activities may be respectively performed by a presence object, SIP activity object, and a videoconference activity object. When the invited user's computing device responds to the invitation, the collaboration service object may determine to which application the acceptance should be routed. Correspondingly, a collaboration service on the invited user's computing device may similarly determine to which application the incoming invitation (i.e., a collaboration event) should be routed. A collaboration event provides signals relating to collaboration services. In an embodiment a collaboration event is an SIP invitation. Alternative protocols that provide signaling, e.g., invitations, may also be used.

The collaboration service object may select applications to which it routes events based on passive considerations, such as policy or preference, or active considerations, such as capabilities or availability. A policy for routing collaboration events may be specified by an administrator, user, or the various objects comprising the architecture. A preference for routing collaboration events may be indicated by users to, e.g., always use a particular media player when rendering incoming media. The collaboration service object may route collaboration events to an application that is capable of handling the incoming collaboration event. As an example, an incoming invitation to answer a Voice over Internet Protocol (“VoIP”) call may be routed to a VoIP application. The collaboration service object may route collaboration events to an application that is available to handle the incoming collaboration event. As an example, when an incoming VoIP call invitation may be handled by multiple VoIP-enabled applications, but one of the VoIP applications is already handling a VoIP call, the incoming call invitation may be routed to another VoIP application. As another example, when a user typing a document using a collaboration-enabled word processor desires to discuss the document with another user, the user may invite the other user to a messaging session using the word processor. The other user's collaboration service object may recognize the incoming invitation as relating to the document, and may route the invitation to the other user's word processor, which may open an instance of the document the first user is typing. Thus, the collaboration service object may provide client-side routing of collaboration events, such as incoming messages using various active or passive considerations.

Applications may register with the collaboration service object to send or receive collaboration events. Then, when the collaboration service object receives a collaboration event, it may route the event to an application (e.g., based on policy, preference, capabilities, or availability). The architecture may have a table associating each registered application with a set of attributes, such as modalities. A modality of an application indicates features of the application and means to invoke the features.

Applications may request the collaboration service object to retrieve updated presence information. As an example, when a user clicks on a “Refresh” pushbutton, the application may attempt to gather the most up-to-date presence information possible. In turn, the collaboration service object may request servers from which it is receiving presence information to provide an updated list. The collaboration service object may then send the updated presence information to the multiple applications that may be registered. Alternatively, the collaboration service object may retrieve the presence information from a presence store. Endpoint objects may update presence information in the presence store. The presence information in the presence store may have an associated “time to live.” When an application requests presence information relating to a URI that is indicated in the presence store to be “alive” (i.e., its time to live is not expired), the collaboration service object may provide presence information from the presence store instead of requesting a server.

In various embodiments, the collaboration service object may aggregate presence information across applications. As an example, if a user is present at a computing device, but an application has not updated its presence information, the collaboration service object may provide updated presence information to the application (or may request the application to update its presence information).

The collaboration service object may start automatically when the operating system it is associated with starts or directs it to start. When the collaboration service object starts, it may start other objects, such as presence and activity objects. It may also start a provider manager (further described below) that helps the collaboration service object manage the other objects. The various objects may each start in a separate application domain (e.g., process space) so that a malfunctioning or malicious object does not interfere with other objects, including the collaboration service object itself.

The provider manager may start and monitor providers. Providers are objects associated with endpoint objects that expose the functionality associated with the endpoint objects to the architecture. The providers provide an API that the provider manager, collaboration service object, applications, and other objects can utilize to receive the associated endpoint object's functionality. The providers may also check for syntax and semantic errors in information received from other objects. As an example, when an application requests the collaboration service object to send a message to a uniform resource identifier (“URI”) not recognized by a provider, the collaboration service object may return an error provided by the provider to the application.

The provider may also provide authentication. As an example, an application or user may not be allowed to use a particular endpoint object. In such a case, the provider associated with the endpoint object may authenticate the application or user sending a request to the endpoint object and respond with an authentication error.

The collaboration service object may be used by a wide variety of applications to provide collaboration services. As an example, an electronic mail (“email”) client could indicate contacts who are presently online. The email client would request the collaboration service object to determine which contacts are presently online. When the collaboration service object returns this information, the email client could provide an appropriate indication to its user. As another example, a developer may wish to provide collaboration or presence information in an application which has a primary function that is not collaboration-related. This developer could use the collaboration service object and its architecture to provide the collaboration service and focus work on the primary functions of the application.

The collaboration service object may provide a facility for applications to share multiple endpoint objects. The collaboration service object may provide a consistent API across a number of endpoint objects so that an application developer may not need to learn details of each endpoint object's API. The developer may instead provide application logic to access an API exposed by an endpoint object via the collaboration service object. Specifically, the developer may not need to provide logic that may be required if the developer uses the endpoint object directly, such as logic for authentication, login, and credential management. The collaboration service object may provide logic for these functions so that the developer may not need to. As an example, if an endpoint object exposes a “ReadStream” method to read messages and another endpoint object exposes a “ReadFrame” method to read messages, the collaboration service object may expose a “ReadMessage” method that is mapped to “ReadStream” or “ReadFrame” depending on which endpoint object is actually used. Applications may indirectly access other aspects of the endpoint objects' APIs not directly provided by the collaboration service object. As an example, if an endpoint object exposes a “Delete” method that is not commonly employed by endpoint objects, the application may use the endpoint object's delete method by sending the delete command to the endpoint object via the collaboration service object. In an embodiment, the collaboration service object may expose the indirectly accessible methods through a function that calls the endpoint object's method directly. For example, the collaboration service object may detect methods that are exposed by an endpoint object, and itself expose those methods directly. Thus, an application can access all interfaces provided by an endpoint object through the collaboration service object.

An application developer desiring to add messaging in an application may provide logic to instantiate a collaboration service object and indicate that messaging services are required in the application. The collaboration service object may then create (or “instantiate”) an endpoint object relating to messaging (such as a SIP endpoint object), a presence object, and a messaging activity object. During subsequent messaging activities (e.g., when sending or receiving messages), the collaboration service object may coordinate the objects it created or instantiated. In an embodiment, the application may create the objects and, optionally, provide an indication of the objects to the collaboration service object. In such a case, the collaboration service object may not need to create these objects.

Thus, by utilizing a collaboration service object, an application developer does not need to need to write specialized logic for each type of collaboration activity or collaboration service provider. Furthermore, because a single collaboration service object coordinates retrieval or storage of a variety of collaboration-related information such as presence or collaboration events, applications may not need to make duplicate requests for such information. Thus, overall system efficiency may increase.

Activity objects provide services to applications and other objects. Activity objects are objects that enable an application to participate in a variety of specific activities, and may include, as examples, instant messaging, teleconferencing, videoconferencing, application sharing, and other activities. Activity objects may be considered to be “wrapper” objects that provide the functionality of underlying objects, including endpoint objects and media stacks. In particular, activity objects coordinate endpoint objects and media stacks to provide a seamless and integrated session to other objects using the activity objects, such as applications.

An example of the benefit of using an activity object is provided by the following example. An application developer may desire to provide videoconferencing capabilities in an application. To do so, the application developer would first have to become familiar with a signaling protocol, such as SIP, and a media protocol, such as RTP/RTCP. Next, the application developer may have to provide application logic to create a session, determine whether a contact with whom videoconferencing is desired is presently online, send an invitation to join a videoconference, negotiate various parameters relating to the videoconference, capture audio and video from sound and video capturing hardware, and finally exchange audio/video data using RTP/RTCP. In contrast, by using a videoconferencing activity object of the architecture, many of these steps are eliminated because the videoconference activity object is especially designed to consolidate this application program logic into a few higher-level interfaces. The architecture has similar activity objects for a variety of other collaboration activities. Furthermore, the architecture provides support for additional activity objects to be added in the future.

An endpoint object provides management services, such as signaling. An endpoint object comprises profile, publishing/subscribing, signaling, and protocol stack components. The profile component may provide an abstraction of a user through an API. The publishing/subscribing component provides interfaces to track presence and availability information relating to users. The signaling component may be used to provide or receive infrequent, transactional messages relating to establishing or controlling sessions. The signaling component may also be used for negotiating, e.g., media parameters such as bandwidth limit. The protocol stack component is used by the profile, publishing/subscribing, and signaling components to send or receive data, and supports various protocols, including SIP.

As previously described, the activity object provides a facility for application developers to add collaboration services to applications easily. As an example, an application developer desiring to add videoconferencing in an application may provide logic to create (or “instantiate”) a videoconferencing activity object. The videoconferencing activity object may then instantiate an endpoint object for signaling (such as a SIP endpoint object) and a messaging media stack for carrying audio/video data. During subsequent videoconferencing activities (e.g., when sending or receiving an audio/video stream), the activity object may coordinate the objects it created or instantiated. In an embodiment, the application may create the objects and, optionally, provide an indication of the objects to the activity object. In such a case, the activity object may not need to create these objects.

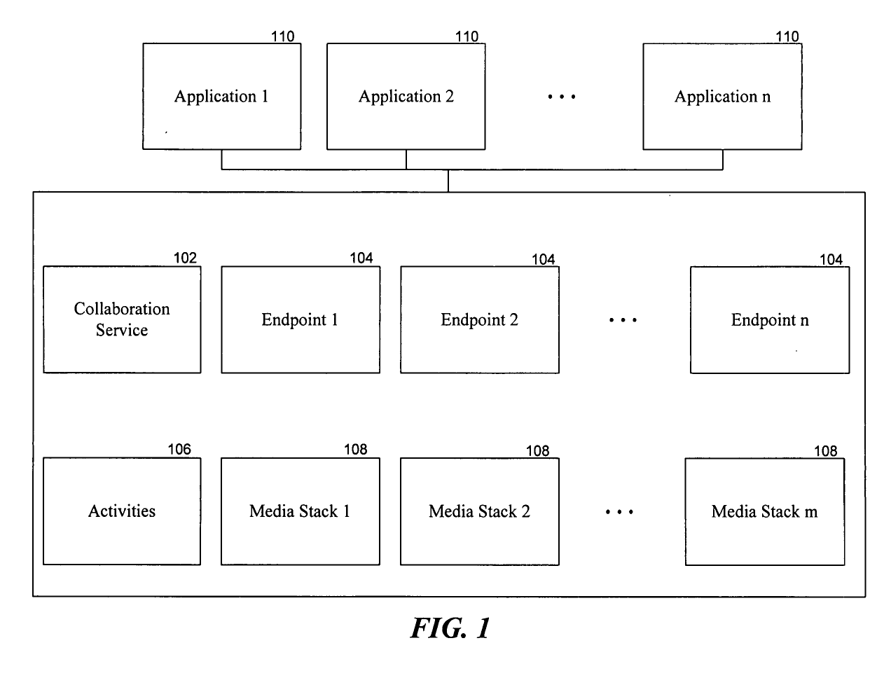

Turning now to the figures, FIG. 1 is a block diagram illustrating components of an architecture for an extensible real-time collaboration system in an embodiment. The architecture for an extensible real-time collaboration system comprises a collaboration service object 102, multiple endpoint objects 104, presence and activity objects 106, and multiple media stacks 108. One or more applications 110 may utilize the architecture by accessing various methods, properties, and events relating to the architecture. An application developer writing an application may utilize the architecture by using a unified API instead of having to learn and implement a different API for each media stack, protocol, or other component that the application may use.

The collaboration service object 102 provides a facility for applications to share multiple endpoint objects and may provide a consistent API across a number of endpoint objects. As an example, if endpoint object A provides an interface relating to receiving (or sending) information, and endpoint object B similarly provides an interface relating to receiving (or sending) information, and the two interfaces use different names but perform similar functions, the collaboration service object may provide a common name for both interfaces. When an application developer uses this common name in an application, the application developer may not need to revise the application when a new or modified object that provides an interface with a different name is used with the collaboration service object.

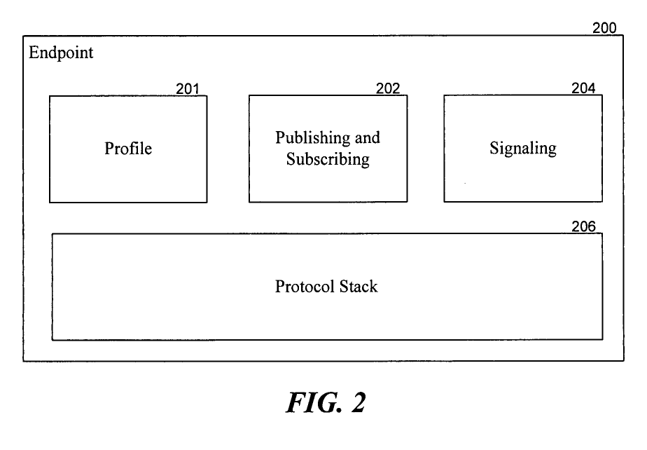

Endpoint objects 104 provide a facility for publishing and subscribing to information. The endpoint objects also provide a facility for signaling other objects. Signaling may be used between two endpoint objects having a session, e.g., so that an endpoint object can invite or request the other endpoint object to conduct an activity or exchange information relating to information of the session. As examples, an endpoint object may invite the other endpoint object of the session to an instant messaging conversation and subsequently may send text messages relating to the conversation. Endpoint objects are further described below in relation to FIG. 2.

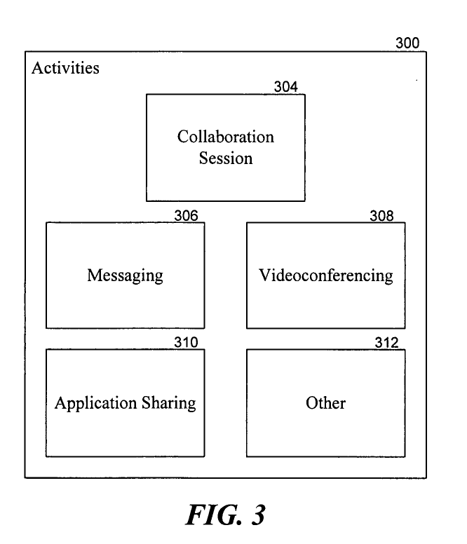

Activity objects are components that enable an application to participate in a variety of collaboration-related activities. These components provide an API that an application developer can use to coordinate endpoint objects and media stacks. Activity objects 106 are further described below in greater detail in relation to FIG. 3.

A media stack object 108 provides content communications services, such as handling data streams, and provides an API for other objects to send or receive the data. The architecture is capable of supporting virtually an infinite number of media stacks by virtue of the fact that the architecture does not need to distinguish between the data or media types. As a result, new media stacks may be added or media stacks may be modified as requirements change. An example of a media stack is RTP/RTCP. This media stack may be used to send audiovisual information.

FIG. 2 is a block diagram illustrating components of an endpoint object of the extensible real-time collaboration system in an embodiment. Endpoint objects provide management services, such as a facility for signaling other objects. Signaling may be used between two endpoint objects having a session, e.g., so that an endpoint object can invite or request the other endpoint object to conduct an activity or exchange information relating to the session. As examples, an endpoint object may invite the other endpoint object of the session to an instant messaging conversation and subsequently may send text messages associated with the conversation.

The architecture may support several varieties of endpoint objects, and each variety of endpoint object may be instantiated multiple times. As an example, there may be an endpoint object relating to a user's personal Internet service provider account (e.g., MSN.COM) and another endpoint object relating to the user's corporate Internet account (e.g., MICROSOFT.COM). The user may be logged in to service providers using the personal account on multiple devices (e.g., a handheld computing device and a desktop computing device) and may also be logged in using the corporate account on some of the devices (e.g., the desktop computing device). Thus, there may be two instances relating to the URI associated with the personal account. Individual instances of endpoint objects may then be uniquely identified by a combination of a uniform resource locator (“URI”) and an endpoint identifier (“EPID”). As an example, an endpoint object may be identified by the URI user@MSN.COM and by the EPID “1234.” As previously described, the EPID may be used to particularly distinguish an instance of an endpoint object from another instance of an endpoint object that is associated with the same URI.

An endpoint object may provide a “data” interface and a “signaling” interface. The data interface may include methods, events, and properties relating to data that is published or subscribed to by the endpoint object. By publishing or subscribing to data, an application may provide data or be notified of changes to data. The signaling interface may provide methods, events, and properties relating to controlling signaling of the endpoint object. As examples, signaling characteristics may include creating or joining sessions, entering or leaving conversations, accepting or declining invitations, and other signals.

The illustrated endpoint object 200 comprises a profile component 201, publishing and subscribing component 202, signaling component 204, and protocol stack component 206.

The profile component may provide an abstraction of a user through an API. It maintains service-related information for the user, such as an electronic address (e.g., URI), credentials used for the service provider, the service provider's status, capability, and policies. Users may have multiple profiles in relation to different service providers. The user could also have more than one profile per service provider. The profile component may be used when creating sessions with other users, e.g., to provide the user's URI. The profile component may provide methods to log on or off a user in relation to a service provider.

The publishing/subscribing component provides interfaces to track presence and availability information relating to users. Presence information relates to whether a user is present at a particular computing device. Availability information relates to whether the present user is available to receive a message or willing to do so. As an example, a user of a cellular telephone may be present when the cellular telephone is turned on, but may be unavailable for a messaging session when the user is participating in a phone call. Similarly, a user who has set a “busy” indication in MICROSOFT WINDOWS MESSENGER may be present but unavailable for messaging.

As further examples, the presence object may provide information relating to a user who is present and available to participate in a MICROSOFT WINDOWS MESSENGER conversation using a computing device and is also available to participate in a teleconference using a cellular telephone. When the user is no longer logged into MICROSOFT WINDOWS MESSENGER, the presence object may update this information so that an application using the presence object is able to determine that the user is no longer present or available to participate in the MICROSOFT WINDOWS MESSENGER conversation. Thus, presence information indicates whether users or other objects are present. Various service providers or protocols may use different mechanisms to produce or provide presence information. So that an application developer does not need to be aware of the multiple ways of producing or providing presence information, an application developer may use the endpoint object to produce or use presence information.

The publishing/subscribing component provides a subscribe interface to create a subscription to another object's publication, a publish interface to provide subscriptions to other objects, and a notify interface to receive notifications relating to services whose publications have been subscribed to. These interfaces enable an application to use the component to provide, receive, or track presence information. As an example, when a user participates in a MICROSOFT WINDOWS MESSENGER conversation using a personal computer and participates in a teleconference using a cellular telephone, the publishing/subscribing component may detect and report the user's presence at both locations. A URI and EID may together uniquely identify instances of endpoint objects. Because a user may be present at multiple locations simultaneously, the user's URI may be indicated as present at these multiple locations. The addition of an EID in relation to a given URI provides a mechanism to uniquely identify a particular instance of presence.

Notifications may be provided relating to various information. As examples, notifications may be provided relating to whether a user is online, busy, available, out for lunch, etc. Notifications may also be provided relating to geographic location of a user (e.g., as provided by a global positioning system or “GPS”) contact information, calendar information, out of office messages, audio/video capabilities, etc.

The signaling component may also be used to provide or receive infrequent, transactional messages relating to establishing or controlling sessions. This component may also be used for negotiating, e.g., media parameters such as frames per second.

The protocol stack object is responsible for sending and receiving information using a protocol. As an example, SIP may be used to send or receive signaling information. In various embodiments, other protocols can equally be used. In an embodiment, an endpoint object may be compatible with multiple protocols. In such a case, the endpoint object may be able to use, e.g., multiple protocols, as necessary, to send or receive information. Alternatively, the architecture may support multiple endpoint object-protocol combinations as separate endpoint objects. In such a case, one endpoint object may be used for SIP and another for some other protocol.

FIG. 3 is a block diagram illustrating activity objects of the extensible real-time collaboration system in an embodiment. Activity objects provide services to applications and other objects. Activity objects are objects that enable an application to participate in a variety of specific activities, and may include, as examples, instant messaging, teleconferencing, videoconferencing, application sharing, and other activities. Activity objects may be considered to be “wrapper” objects that provide the functionality of underlying objects, including endpoint objects and media stacks. In particular, activity objects coordinate endpoint objects and media stacks to provide a seamless and integrated session to objects using the activity objects, such as applications.

Each activity object provides functionality that enables an application using the object to participate in a variety of activities. As an example, an activity object may encapsulate signaling and media information. In doing so, the activity object may serve as a bridge between signaling and media, so that an application using the activity object is provided an integrated view. For example, an application developer would merely request a videoconference rather than having to set up separate SIP and RTP/RTCP connections and sessions. The illustrated examples of activity objects are described below.

A collaboration session activity object 304 enables an application to provide collaboration services to the application's users. As an example, the collaboration session activity object may enable two users using two different computers to collaborate by authoring a shared document.

An application sharing activity object 310 enables an application using the application sharing activity object to provide functionality relating to the sharing of applications between users using different computing devices. As an example, two users may share a “whiteboard” application, e.g., using which a user can provide visual information that the other user can view and manipulate.

A messaging activity object 306 provides an ability for applications to provide messaging capabilities to the application's users. As an example, an application developer may want to enable messaging within an application the developer is creating. As a specific example, when two users are collaborating on a document by simultaneously editing a document, the users may want to be able to send text messages to one another or participate in a videoconference during the collaboration. In such a case, an application developer may use a collaboration session activity object as well as messaging or videoconferencing activity objects to enable users to collaborate and exchange messages with one another during the collaboration.

A videoconferencing activity object 308 provides videoconferencing facilities to an application. Videoconferencing may involve sending and receiving audiovisual information.

Additional activity objects are also contemplated, and are represented as activity objects 312.

An application developer may use objects of the architecture described above (and those not listed or described) by utilizing APIs provided by the objects. These objects may provide an easy-to-use API so that an application developer may not need to reference APIs provided by underlying components that provide the services associated with the activity object. As an example, a messaging service provider may provide an API that a developer could use. To do so, the developer may need to spend time to learn the API, which can be quite complicated. Instead, the developer may wish to use a simpler API provided by an object of the architecture. Furthermore, the object may encapsulate steps that may be required to use multiple different objects. As an example, an application developer wishing to exchange messages between two computers may need to utilize an API provided by the SIP as well as an API exposed by another low-level object that provides messaging services. In contrast, the application developer would only need to use the messaging activity object, and thereby be able to add messaging functionality to an application much more easily. Furthermore, the framework may operate to coordinate multiple objects, thereby requiring less programming logic from the application developer.

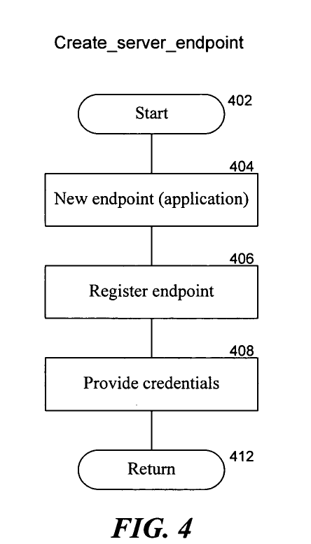

FIG. 4 is a flow diagram illustrating a create_server_endpoint routine in an embodiment. The routine is called by an application to create an endpoint object at a server. When an endpoint is created at a server, information it publishes may be available to subscribing objects even after the created endpoint is no longer operating. Thus, an endpoint created at a server may provide per-URI information.

The routine begins at block 402. At block 404, the routine creates a new endpoint object at the server, and indicates that the endpoint is related to an application. The indicated application may be provided as a parameter to a create function that operates to create the endpoint on the server. When creating an endpoint, a “friendly” name may be provided so that the endpoint may be referenced by the friendly name. Alternatively, the newly created endpoint may be referenced by a unique identifier associated with the endpoint. This unique identifier may be generated by the system when the object is created.

At block 406, upon creating the endpoint, the application may register the newly created endpoint object to allow the server and the endpoint to route messages. Upon attempting to register the endpoint object, the server may issue a challenge to the application. The challenge may contain a “realm” used by the server. A realm may indicate a domain name associated with the server. As an example, the server may issue a challenge with the realm “MICROSOFT.com.”

At block 408, the routine responds to the challenge by providing credentials (e.g., user id and password) associated with the application. These credentials may be supplied by a user or provided automatically. The server may validate the credentials that the routine supplies. The credentials may be associated with the realm. For example, if the application provides credentials that are not associated with the server's realm (“MICROSOFT.com”), the server may not authenticate the application.

If the registration is successful, the endpoint may be ready to receive messages from other objects. Otherwise, the endpoint may be unable to receive messages.

The routine returns to its caller at block 412. In an embodiment, the server may enable an endpoint that is not successfully registered to send messages but not receive messages. Alternatively, in a weaker security model, the server may enable any endpoint to send or receive messages.

In an embodiment, the server may challenge an endpoint when the endpoint attempts to send a message but not when it receives messages.

An alternate routine (not shown) may create a peer-to-peer endpoint. A peer-to-peer endpoint is one that is not associated with a server. When an endpoint is not associated with a server, information the endpoint publishes may not be available once the endpoint stops operating.

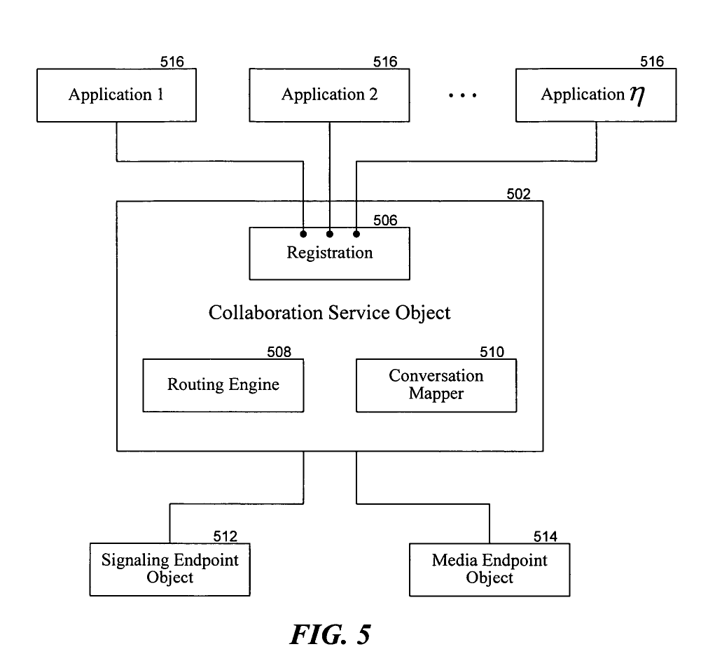

FIG. 5 is a block diagram illustrating a collaboration service object in an embodiment. The collaboration service object 502 comprises a registration interface 506, routing engine 508, and conversation mapper 510.

The registration interface handles registrations of applications, such as applications 516. The registration interface may provide an API for applications to register themselves. Alternatively, the registration interface may read a registry comprising a list of registered applications.

The routing engine 508 routes collaboration events, such as invitations. Collaboration events may be routed to an application that is registered with the collaboration service object based on policies, user preferences, capabilities, and availability of applications. As an example, a system administrator may have indicated that all invitations to or from a particular application or user should be routed to an application indicated in a policy. As another example, a user may have indicated to route all invitations relating to a voice over IP (“VoIP”) to a preferred VoIP application. As another example, an invitation to a video conference may be routed to a video conferencing application because that is the only application installed on an operating system associated with the collaboration service object that provides video conferencing capabilities.

The conversation mapper 510 may provide information to the collaboration service object relating to ongoing conversations. As an example, if multiple applications are subscribed to events from a particular URI, and the URI is presently engaged in a conversation with an application registered with the collaboration service object, then a second application that desires to know the URI's present status could receive this information from the collaboration service object without the collaboration service object having to query a server. Thus, the second application does not need to wait for a response from a server.

The collaboration service object may utilize multiple endpoint objects. As examples, it may utilize a signaling endpoint object 512 and a media endpoint object 514. The signaling endpoint object may provide signaling services to the collaboration service object, such as to receive invitation, invite another user, or terminate a conversation. A SIP endpoint object may provide signaling over the SIP protocol. A media endpoint object, such as a video conferencing endpoint object, may provide media-related services to the collaboration service object.

Multiple applications may use a collaboration service object, as indicated in FIG. 5.

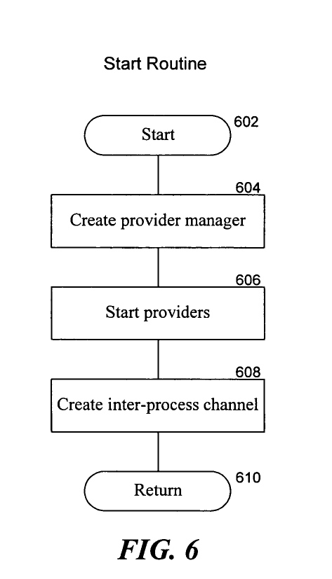

FIG. 6 is a flow diagram illustrating a startup routine performed by a collaboration service object in an embodiment. The startup routine begins at block 602.

At block 604, the startup routine creates a provider manager. A provider manager may be created as a “singleton” server object. A singleton server object is an object which may only have one active instance in an operating system. When a second singleton object is created, the second object would shut down as a first object is already instantiated and running.

At block 606, the routine starts providers. Providers are objects that provide services to the collaboration service object. Examples of providers are endpoint and activity objects. In an embodiment, the provider manager created at block 604 starts the providers.

At block 608, the routine creates an inter-process channel. The inter-process channel may be used by the collaboration service object, registered applications, and other components to communicate with one another. As an example, a provider may provide an event to the collaboration service object by sending a message over the inter-process channel. The collaboration service object may forward the event using the inter-process channel to a selected application, and so on.

The routine returns at block 610.

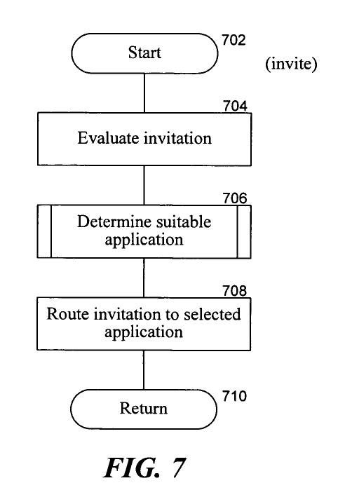

FIG. 7 is a flow diagram illustrating a listen routine performed by a collaboration service object in an embodiment. The listen routine begins at block 702 where it receives a collaboration event (e.g., a SIP “invite” message).

At block 704, the routine evaluates the received collaboration event. Evaluating the received collaboration event may include, e.g., evaluating a sender of the received collaboration event, a recipient of the received collaboration event, or other fields contained in the header or the body of the received collaboration event.

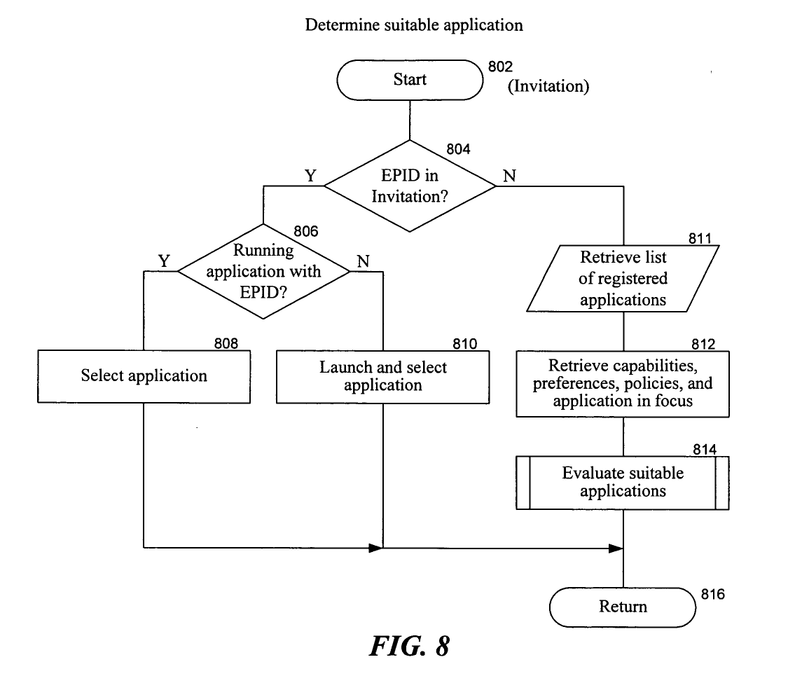

At block 706, the routine determines a suitable application for the received collaboration event. A subroutine for determining a suitable application is described below in relation to FIG. 8. Determining a suitable application may include evaluating policies, preferences, capabilities, and availability, as previously discussed. Upon determining a suitable application, the routine selects the application.

At block 708, the routine routes the received collaboration event to the selected application. Routing the collaboration event may include launching the application and providing it with the received collaboration event, e.g., utilizing the inter-process channel discussed above in relation to FIG. 6. The routine may only need to launch the application once. In an embodiment, the routine may launch the application for every collaboration event.

At block 710, the routine returns.

FIG. 8 is a flow diagram illustrating a routine for determining a suitable application in an embodiment. The routine begins at block 802 where it receives an invitation as a parameter. An invitation may be a message received from another client or object, e.g., an endpoint object. As an example, an invitation may be a SIP INVITE message.

At block 804, the routine determines whether an endpoint ID is indicated in the invitation. If an endpoint identifier (“EPID”) is indicated, the routine is quickly able to determine an appropriate application to which the invitation should be routed. If that is the case, the routine continues at block 806. Otherwise, the routine continues at block 811.

At block 806, the routine determines whether an application is presently running that is associated with the EPID. If that is the case, the routine continues at block 808. Otherwise, the routine continues at block 810.

At block 808, the routine selects the already-running application associated with the EPID.

At block 810, because the application is not already running, the routine launches the application associated with the endpoint ID, and selects the application.

At block 811, the routine retrieves a list of registered applications. As an example, applications may be registered in a registry associated with the operating system on which the architecture is operating.

At block 812, the routine retrieves indications of capabilities, preferences, and policies of registered applications and the application in focus. This information may be retrieved from a variety of information sources associated with the architecture. As examples, applications may register their capabilities; users may indicate preferences using a user interface that may store the indicated preferences; an administrator may provide policies in a policy document; and the application in focus may be determined by querying the operating system on which the architecture is operating.

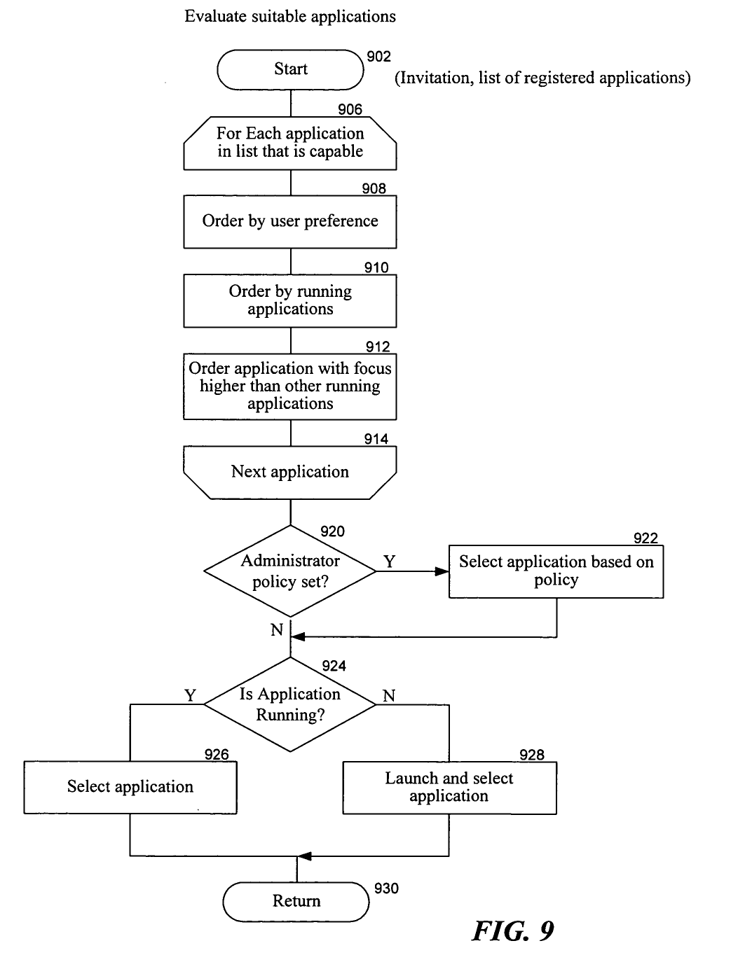

At block 814, the routine evaluates suitable applications. A subroutine for evaluating suitable applications is described in detail below in relation to FIG. 9.

The routine returns at block 816.

FIG. 9 is a flow diagram illustrating a routine for evaluating suitable applications in an embodiment. The routine begins at block 902, where it receives an invitation and a list of registered applications as parameters. The invitation is described above in relation to FIG. 8.

Between blocks 906 and 914, the routine attempts to evaluate and select a suitable application from the set of registered applications.

At block 906, the routine skips any application that is not capable of handling the received invitation. As previously described, determining whether an application is capable of handling an invitation may include evaluating capabilities indicated by the application when the application registers.

At block 908, the routine orders the capable applications by user preference when user preferences are indicated. Users may have indicated preferences such as which application(s) should handle particular types of invitations. As an example, a user may have indicated that a particular multimedia application should handle incoming invitations for video conferencing.

At block 910, the routine orders running applications higher in the order than those that are not running. As an example, when multiple applications are indicated as preferred for a particular type of invitation, the routine may order running applications that are preferred higher than preferred applications that are not running.

At block 912, the routine orders the application with a focus higher than other running applications. As an example, when multiple running applications are capable of handling an invitation, and a user preference is either not indicated or is not indicated to prefer one of the running applications, an application that has focus may be selected. An application has focus when it is an application that actively receives a user's input when multiple applications are running. In various embodiments, an active application is the one that appears “on top” of other applications in a windowing environment.

At block 914, the routine iterates to the next application.

At block 920, the routine determines whether an administrator has indicated a policy. If an administrator has indicated a policy, the routine continues at block 922. Otherwise, the routine chooses the application ordered highest, and continues at block 924.

At block 922, the routine chooses the application based on an indicated policy.

At block 924, the routine determines whether the indicated application is running. If the indicated application is running, the routine selects the application at block 926. Otherwise, the routine launches the indicated application and selects it at block 928.

At block 930, the routine returns.

In an embodiment, policies may be indicated using rules. As an example, a policy may be to choose a default application when no preference is indicated. Various rules are possible. Multiple rules may be evaluated before an application is chosen.

Applications may call methods of objects of the architecture, or may directly call methods of underlying objects that implement functionality. By calling methods of the architecture's objects, application developers may need to provide less logic, and may not need to revise the application logic when the underlying components change.

In an embodiment, an application for receiving a collaboration event may be selected based on a URI provided in the event.

In an embodiment, the architecture is compatible with prior versions of the architecture or other providers of collaboration services. In this embodiment, methods, events, and properties of the collaboration service may map to corresponding methods, events, and properties of the prior version or other providers of collaboration services.

In an embodiment, applications components register themselves by creating registry entries and adding registry keys and values.

In an embodiment, the collaboration service object is not a logical object, but provides functions to applications.

The following methods and properties may be provided by the architecture. Additional methods and properties are equally contemplated. Only some of the possible parameters and return values are provided, and others are also contemplated.

Methods

An AddContact method receives an indication of a contact as a parameter and adds the indicated contact to a set of contacts. The method returns an indication of whether the addition succeeded or failed.

An AutoLogon method requests a service provider (e.g., MICROSOFT WINDOWS MESSENGER) to log in without prompting for a user's login credentials. The method may receive the user's login credentials as parameters. The method returns an indication of whether the login succeeded or failed.

An AddParticipant method adds a contact to an open session (see “CreateSession,” immediately below). The method may accept an indication or URI of the contact and a friendly name for the contact that can be displayed. The method may return an indication of the contact or an error.

A CreateSession method creates a session. As an example, the method may be used to create a SIP session. The method may receive as parameters a session type (e.g., text messaging, voice messaging, etc.) and a phone URI of the user (in the case of voice messaging). The method may return an indication of the newly created session or an error. Once a session is created, the application may add participants to the session by calling the AddParticipant method.

An InviteApp message sends an invitation to a set of contacts to collaborate using an application. The method accepts as parameters indications of a set of contacts and application. The method may return an indication of whether the sending failed, the contacts accepted the invitation, or the contacts declined the invitation.

A LaunchIMUI method causes a user interface relating to a messenger application, e.g., MICROSOFT WINDOWS MESSENGER, client to be launched. It may accept an indication of the messenger application as a parameter, and return an indication of the launched application or failure.

A SendMessage method sends a message to a set of contacts. The method may receive as parameters a message header (e.g., in Multipurpose Internet Mail Extensions or “MIME” format) comprising the type of message, the message's contents, and a “cookie” value that may be used as an identification number for this message so that a subsequent responsive notification may be paired with the message. The method may further accept a parameter indicating whether the message should be sent in clear text or encrypted. The method may return an indication of whether the message was sent or the sending failed.

A StartVideo method starts a video session. The method may receive an indication of a session as a parameter. Alternatively, the method may receive an indication of a set of contacts as a parameter. The method could start a video session with participants in the session or those indicated. The method may return an indication of success or failure.

Properties

A Blocked property indicates whether a contact is blocked from sending messages to the user whose application is checking the property.

A CanPage indicates whether a contact can be paged using a paging system.

An IsSelf property indicates whether a contact is the user whose application is checking the property.

A MyServiceId property provides an indication of an identifier of a service provider providing the service being used.

A MyServiceName property provides an indication of a name of a service provider providing the service being used.

A MyStatus property provides an indication of the user's messenger status such as online, busy, away, etc.

The computing device on which the architecture is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communications link. Various communications links may be used, such as the Internet, a local area network, a wide area network, or a point-to-point dial-up connection.

The architecture may be implemented in a variety of operating environments, including computing devices running a MICROSOFT WINDOWS operating system. This operating environment is only one example of a suitable operating environment and is not intended to suggest any limitation as to the scope of use or functionality of the system. Other well-known computing systems, environments, and configurations that may be suitable for use include personal computers, server computers, hand-held or laptop devices including “smart” cellular telephones, multiprocessor systems, microprocessor-based systems, programmable consumer electronics, network PCs, minicomputers, mainframe computers, distributed computing environments that include any of the above systems or devices, and the like.

The architecture may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A method performed by a computing system for providing real-time collaboration services to an application, comprising:
receiving a signal from another computing system relating to a request for a collaboration service; and
selecting an application for providing the requested collaboration service based on at least an active or passive consideration.

2. The method of claim 1 wherein the request is for a text messaging session.

3. The method of claim 1 wherein the request is for a Voice over Internet Protocol session.

4. The method of claim 1 wherein the request is for videoconferencing.

5. The method of claim 4 wherein the signal is an invitation carried by a Session Initiation Protocol.

6. The method of claim 1 wherein the active consideration is a capability of the application.

7. The method of claim 1 wherein the active consideration is an availability of the application.

8. The method of claim 1 wherein the active consideration is whether the application is in focus.

9. The method of claim 1 wherein the passive consideration is a user preference.

10. The method of claim 1 wherein the passive consideration is a policy.

11. The method of claim 1 wherein the policy comprises rules.

12. A method performed by a computing system for providing real-time collaboration services to an application, comprising:
coordinating multiple collaboration service providers to complete a collaboration service requested by the application;
collecting multiple collaboration events from the multiple collaboration service providers, the collecting performed by a collaboration service object, the collaboration service object providing a unified interface;
receiving a request for an updated set of collaboration events; and
providing the collected multiple collaboration events.

13. The method of claim 12 wherein the multiple collaboration events include an indication of presence.

14. The method of claim 13 wherein the indication includes a uniform resource identifier.

15. The method of claim 12 wherein the collaboration service object provides a unified interface to the application.

16. The method of claim 15 including receiving registration information relating to multiple applications.

17. The method of claim 12 wherein the collaboration service object provides a unified interface to the multiple service providers.

18. An extensible real-time collaboration system, comprising:
a collaboration service object, wherein the collaboration service object provides a unified application program interface to applications and utilizes an endpoint object, presence object, or activity object to provide collaboration services in a unified model wherein the application developer does not need to change application logic when a different endpoint object, presence object, or activity object is used that provides functionality similar to the utilized activity object or endpoint object; and
a component relating to the collaboration service object that causes multiple providers to start, the providers providing collaboration services.

19. The extensible real-time collaboration system of claim 18 wherein the component relating to the collaboration service object is a provider manager.

20. The extensible real-time collaboration system of claim 18 wherein one of the multiple providers is an endpoint object.

21. The extensible real-time collaboration system of claim 18 wherein one of the multiple providers is a presence object.

22. The extensible real-time collaboration system of claim 18 wherein one of the multiple providers is an activity object.

23. The extensible real-time collaboration system of claim 18 wherein the component starts the providers.

24. The extensible real-time collaboration system of claim 18 wherein the collaboration service object starts the providers.

25. A computer-readable medium having computer-executable instructions for providing an extensible real-time collaboration system, comprising:
adding a collaboration service provider;
receiving a collaboration event from the added collaboration service provider;
evaluating the received collaboration event;
determining a subset of suitable applications from a set of registered applications for the received collaboration event, the determining based on the evaluation;
selecting an application from the subset of suitable applications; and
sending the collaboration event to the selected application.

26. The computer-readable medium of claim 25 wherein the evaluating is based on a uniform resource identifier indicated in the collaboration event.

27. The computer-readable medium of claim 25 wherein the determining is based on a policy.

28. The computer-readable medium of claim 25 wherein the determining is based on a preference.

29. The computer-readable medium of claim 25 wherein the determining is based on a capability.

30. The computer-readable medium of claim 25 wherein the determining is based on availability.
